(19) United States
(12) Patent Application Publication
(10) Pub. No.: US 2008/0311539 A1
(43) Pub. Date: Dec. 18, 2008

(54) ORTHODONTIC FACEBOW

(76) Inventors: Yuli LOZINSKI, Jerusalem (IL); Naphtalk Brezniak, Tel-Aviv (IL)

Correspondence Address: DANIEL J SWIRSKY, 55 REUVEN ST., BEIT SHEMESH, 99544, IL

(21) Appl. No.: 12/136,123

(22) Filed: Jun. 10, 2008

(30) Foreign Application Priority Data
Jun. 12, 2007 (IL) IL183856

(51) Int. Cl. A61C 19/04

(52) U.S. Cl. 433/73

(57) ABSTRACT

The invention provides an orthodontic facebow of the type, having an inner bow consisting of two inner arms, each including an end portion, and an interconnected outer bow consisting of outer arms, characterized in that the free end portion of each inner arm is self-locking element to realize by means of placing lever in form of segment of a circle or placing lever into split and fixing to inner with help axle and with possibility tuning so as to allow it to be easily inserted facebow in buccal tube and after inserted lever tune and stopping facebow, and then for facilitating removal facebow from buccal tube need to combine said levers with each inner arms.

### CROSS-REFERENCE TO RELATED APPLICATIONS

This application claims priority from Israel Patent Application No. 183,856, filed Jun. 12, 2007, incorporated herein by reference in its entirety.

### FIELD OF THE INVENTION

The present invention relates to orthodontics devices and more specifically to extra-oral appliances equipped with a self locking mechanism.

### BACKGROUND OF THE INVENTION

U.S. Pat. No. 5,695,332 to Samuels and U.S. Pat. No. 6,908,305 to Dinkelis et al. describe facebows that are typically used in orthodontics as adjunctive appliances to straighten teeth, mainly in the maxilla, and in rare cases, also in the mandible. Usually, these devices include a metal band that is coupled to the first molar and is welded, or rigidly attached, to a bracket or tube having a longitudinal opening with a central axis facing the mouth opening. Alternatively, said tube or bracket may be coupled directly to a tooth using special attachment

Such a facebow comprises a C-shaped inner metal bow having opposite ends or feet retained in the tubes or the bracket. When in use, the inner bow encircles the labial and buccal portions of the patient's teeth. The facebow is connected to an outer bow at a central location, by welding or soldering. The outer bow has arms which encircle the user's cheeks. The free ends of the outer bow are bended and serve as hooks, to which an elastic band or spring are attached, and when worn, extends around the rear of the neck or head or both. When worn properly, the facebow is activated against the teeth, which push them backwards, due to the tension supplied by the band or spring. It is important to note that the facebow is held in contact with the back teeth only when restrained by the bracket or the tubes which have a longitudinal opening. The elastic band prevents disengagement of the ends of the inner bow from the opening. Various designs, all basically according to this description, are disclosed in U.S. Pat. Nos. 4,087,915, 4,588,380 and in 4,764,110.

Should the elastic band inadvertently become disengaged or break, the ends of the inner bow would be free to disengage from the tubes or bracket, in which eventuality, the extremities of the inner bow can cause serious injury to the mouth tissues, or even penetrates the user's cheeks or worse, the user's eye. The same result would occur if the facebow were pulled outwards, without being released from the elastic band, as could happen, for example, when children quarrel. This serious safety problem has long been recognized. Further, as intended, assembly and removal of the device to a patient must be reasonably easy.

This situation calls for some method of temporarily and selectively preventing inadvertent release of the facebow, while yet allowing its release when required or desired.

### SUMMARY OF THE INVENTION

The object of the present invention is to prevent the disadvantages of such prior art orthodontic devices and to provide a safer device.

An aspect of some embodiments of the invention relates to a facebow having an inner arm, said inner arm incorporates an automatic self locking device for prevention of withdrawal of the said facebow from the tube. Optionally, said self-locking device is located on the distal end of said facebow inner arm. In one embodiment of the present invention, said inner arm further includes a release device manually accessible by the operator that aims at improving the safety and ease the removal of the facebow, when intended.

In a second embodiment of the invention, said self locking device of said inner arm includes a lever apparatus. In an exemplary embodiment of the invention, said lever apparatus is activated to a locking position by sliding a wire (e.g. a facebow wire) through the buccal tube. Preferably, when said locking position is achieved, the facebow is situated in a substantially firmed manner within patient's mouth. In an exemplary embodiment of the invention, said self-locking device is switched to an opened position when it is lifted by the operator while allowing the wire to slide and be released from the tube and the patient's mouth.

### BRIEF DESCRIPTION OF THE DRAWINGS

The invention will now be described in connection with certain preferred embodiments with reference to the following illustrative figures so that it may be more fully understood. With specific reference now to the figures in details, it is stressed that the particulars figures shown are by way of example and for purposes of illustrative discussion of the preferred embodiments of the present invention only, and are presented in the cause of providing what is believed to be the most useful and readily understood description of the principles and conceptual aspects of the invention. In this regards, no attempt is made to show structural details of the invention in more details than is necessary for a fundamental understanding of the invention. The description taken with the drawings making apparent to those skilled in the art how the several forms of the invention may be embodied in practice.

In the drawings:

FIG. 1 is a schematic representation of a prior art facebow attached to a tooth fitted with a band and coupling tube as seen from above.

FIG. 2a is a side view of the free end of the facebow with self-locking element-lever and FIGS. 2b and 2c are an enlarged, cross-section view for section A-A and B-B in FIG. 2a.

FIG. 3 is an enlarged, cross-sectional view the free end of the facebow with split for the self-locking element.

FIGS. 4a, 4b and 4c are a view of the buccal tube and free end of the facebow with self-locking element before, into and after insertion respectively.

### DETAILED DESCRIPTION

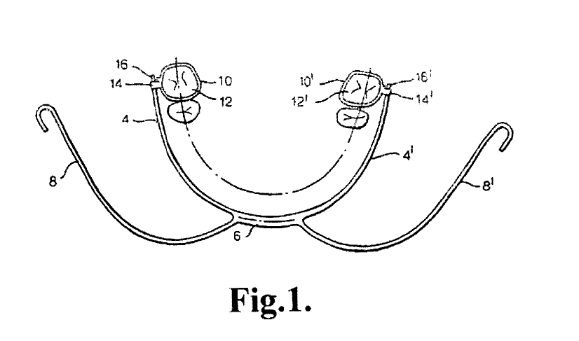

Referring to FIG. 1, there is an illustration of a commonly used prior art metallic wire facebow, comprising a C-shaped, inner bow consisting of inner arms 4, 4 connected at the middle portion 6 to an outer bow consisting of outer arms 8, 8′. Further seen are metal bands 10, 10′ cemented around teeth 12, 12 which bands are provided with coupling tubes 14, 14′. The free ends 16, 16′ of the inner arms 4, 4′ are inserted into tubes 14, 14′ and are affixed in this position by various ways and means, such as those described in the above-mentioned prior art patents.

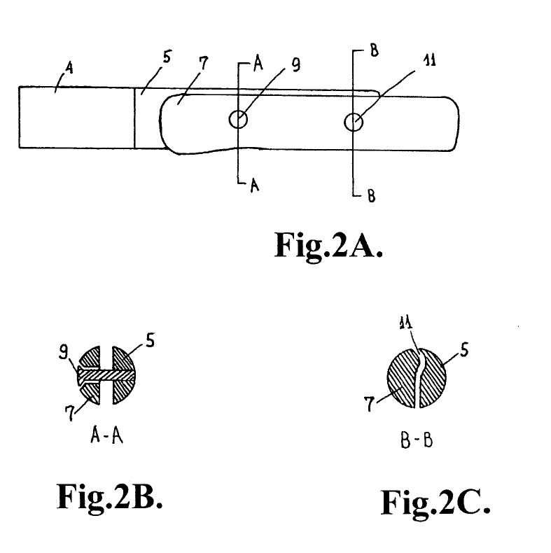

FIG. 2a illustrates the rear end of the inner arm 4 and attached lever 7 fixed to the inner arm 4 with an axle 9 with tuning possibility. Both, the very rear part of the inner arm 5 and the lever 7 are in the shape of half a circle as seen in a sections A-A and B-B, and when placed together with their straight surface form a full circle or similar shape. The axle 9 is being placed nonsymmetrical relative to the said lever 7 length. On both straight surfaces of the lever 7 and the inner arm 5 there are the fixing elements 11, as a bulge and indentation respectively, and when in contact it fixes the said lever of the facebow in a horizontal position ready for insertion and release the facebow 2 from the tube 14, 14′. FIGS. 2b and 2c illustrated an enlarged, cross-section view for section A-A and B-B, which shown the axle 9 and the fixing elements 11.

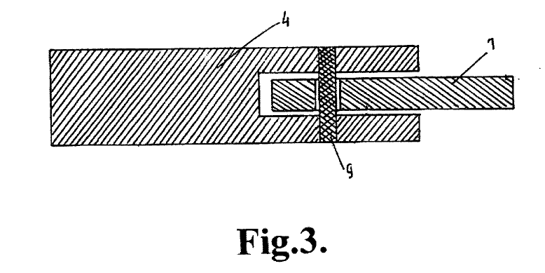

FIG. 3 illustrates the rear end of the inner arm 4 in another embodiment of the invention, where a split for the self-locking element is engaged. The Lever 7 is attached to the inner arm 4 with a help an axle 9. The same fixing element 11 as shown in FIGS. 2a and 2c is built in this version as well.

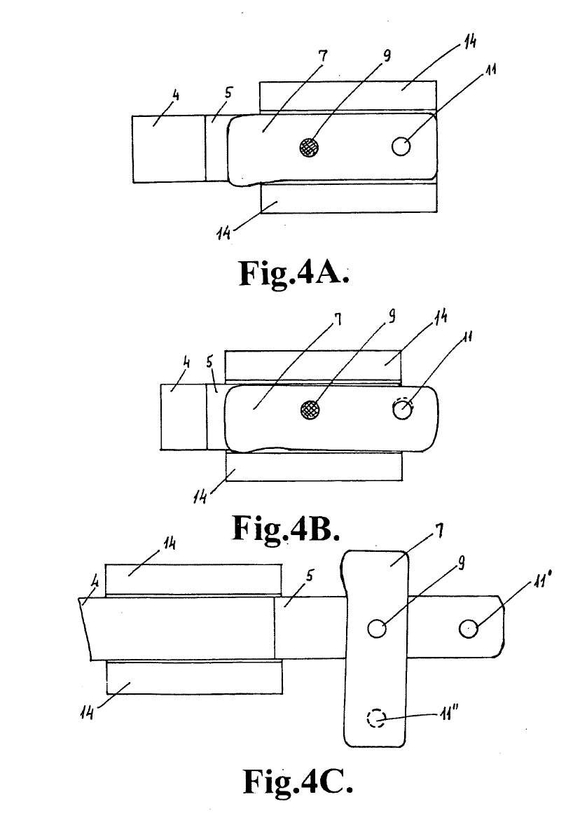

FIGS. 4a, 4b and 4c illustrate a view the buccal tube and the free end of the facebow with a self-locking element before, into and after its insertion respectively. Usually the lever 7 is in a horizontal position (FIG. 4a), but when the inner arm 4 enters through the buccal tube 14, the lower part of the lever disengage the fixing elements 11 (FIG. 4b) and release it. When the lever 4 passes through the tube 14, the lever is free to self-lock by changing its position to a vertical one (FIG. 4c). For facilitating removal of the facebow from the buccal tube it is needed to push the lever 7 upwards to a straight position, and fix both parts together using the fixation mechanism 11.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. An orthodontic facebow with a self locking lever mechanism, fixed with an axle placed nonsymmetrical relative to the lever length, and a fixation element, located at the rear end of at least one side of the inner arm of the said facebow, preferred both; said facebow is attached to a user's mouth using a buccal tube coupling; wherein the locking action thereof being automatically effected upon insertion of the inner arm wire through the buccal tube, and thus preventing axial withdrawal thereof from the tube, wherein said self-locking mechanism is configured to be released simultaneously when said facebow is selectively withdrawn from the tube by the user.

2. The orthodontic facebow as claimed in claim 1, wherein self-locking lever and inner arm are in form of segments of a circle or similar shape.

3. The orthodontic facebow as claimed in claim 1, wherein self-locking lever is placed into a split of the inner arm.
